(19) United States
(12) Patent Application Publication
(10) Pub. No.: US 2026/0312904 A1
(43) Pub. Date: Oct. 8, 2026

(54) OPTICAL PATH DESIGN DEVICE, OPTICAL PATH DESIGN METHOD, AND OPTICAL PATH DESIGN PROGRAM

(71) Applicant: NTT, Inc., Tokyo (JP)

(72) Inventors: Hanami YOKOI, Musashino-shi, Tokyo (JP); Kotaro ONO, Musashino-shi, Tokyo (JP); Kojun Koshiji, Musashino-shi, Tokyo (JP); Kazuhiro Tokunaga, Musashino-shi, Tokyo (JP); Tatsuya MATSUKAWA, Musashino-shi, Tokyo (JP); Takashi MIYAMURA, Musashino-shi, Tokyo (JP)

(21) Appl. No.: 19/480,460

(22) PCT Filed: May 18, 2023
(86) PCT No.: PCT/JP2023/018611

§ 371 Date: Oct. 31, 2025

(51) Int. Cl. H04L 45/00

(52) U.S. Cl. CPC H04L 45/62

(57) ABSTRACT

An optical path design device (100) sets an optical path that connects one fixed node which is a fixed endpoint and a plurality of switching nodes which are endpoints to be switched at different times. Thus, the optical path design device (100) includes a route calculation unit (21) that calculates a route of an optical path that includes a route obtained by collecting common routes of a plurality of optical paths, for the route of the optical path for each switching node that connects the fixed node and each switching node, and an optical path control unit (22) that reserves communication resources used by an optical path whose period of use and wavelength used are designated on the route of the optical path calculated by the route calculation unit (21), and opens the optical path that uses a reserved wavelength in a reserved period of use.

### TECHNICAL FIELD

The present invention relates to an optical path design device, an optical path design method, and an optical path design program.

### BACKGROUND ART

An optical path used in an optical transmission system is configured along a route from one endpoint to another endpoint. Network resources for optical transmission systems, such as the number of simultaneously available optical paths, are limited. For this reason, in order to meet a large amount of communication demands on an optical transmission system, it is required to design a route of an optical path that yields high efficiency of utilization of network resources.

Thus, as optical multicast, there has been proposed an optical path connection form that allows “one-to-many simultaneous communication” in which multiple endpoints communicate simultaneously with one endpoint in an optical layer. NPLS 1 and 2 describe an optical multicast route selection algorithm. By using optical multicast, it is possible to design multi-endpoint optical paths for one endpoint.

### CITATION LIST

### Non Patent Literature

[NPL 1] Xijun Zhang, John Y. Wei, and Chunming Qiao, “Constrained Multicast Routing in WDM Networks with Sparse Light Splitting,” J. Lightwave Technol. 18, 1917-(2000)
[NPL 2] L. H. Sahasrabuddhe and B. Mukherjee, “Light trees: optical multicasting for improved performance in wavelength routed networks,” in IEEE Communications Magazine, vol. 37, no. 2, pp. 67-73, February 1999, doi: 10.1109/35.747251.

### SUMMARY OF INVENTION

### Technical Problem

It should be noted that one-to-many communications connecting one endpoint and multiple endpoints in an optical layer are not limited only to one-to-many simultaneous communications. Communications for multiple endpoints do not occur at the same time even in one-to-many communications, and there are communication demands where multiple endpoints may be able to communicate with one endpoint at different times (time-sequentially) (hereinafter, “one-to-many switching communication”). In the following, for example, one-to-many switching communication will be examined in which history data generated at one endpoint user base is distributed and backed up to a data center at a multi-endpoint.

In this case, the data transmission from the user base to the data center to which the user base is connected may be performed simultaneously at one data center, and in the meantime connection with other data centers is not performed. Then, after completing data transmission to a certain data center, the user base may switch the connection to another data center to start data transmission.

FIG. 8 is a configuration diagram showing a network topology obtained before an optical path is configured in an optical transmission system 200A.

In FIG. 8, a total of 16 nodes (4 nodes vertically×4 nodes horizontally) for setting up the optical path are prepared. Specifically, the nodes A1 to A4 in the first column, the nodes B1 to B4 in the second column, the nodes C1 to C4 in the third column, and the nodes D1 to D4 in the fourth column are connected in a lattice shape.

Also, a user base Y is housed in the node D4 corresponding to “1” in one-to-many communication. Bases X1, X2, and X3 are housed in the nodes A1, A2, and A3 corresponding to “many” of one-to-many communication, respectively. Here, it is assumed that the user base Y performs one-to-many switching communication with the bases X1, X2, and X3.

FIG. 9 is a configuration diagram showing an optical transmission system 200B that prepares a plurality of one-to-one communications in the optical transmission system 200A shown in FIG. 8.

In the optical transmission system 200B, an optical path to each of the bases corresponding to “many” is created as a separate route, which is a unicast optical path, as described below.
The first optical path passes through the route of the nodes D4, D3, D2, D1, C1, B1, A1 and connects the user base Y and the base X1.
The second optical path passes through the route of the nodes D4, D3, D2, C2, B2, A2 and connects the user base Y and the base X2.
The third optical path passes through the route of the nodes D4, C4, B4, A4, A3 and connects the user base Y and the base X3.
   In the method shown in FIG. 9, even in one-to-three switching communication, in order to make three optical paths available at all times, each of the nodes on the routes of the three optical paths always occupies wavelengths, and therefore the network resources are not utilized efficiently.

FIG. 10 is a configuration diagram showing an optical transmission system 200C that prepares one-to-many simultaneous communication in the optical transmission system 200A shown in FIG. 8.

In the optical transmission system 200C, an optical path to each of the bases corresponding to “many” is created as a multicast optical path such as the ones described in NPLs 1 and 2, which branches from one to three along the way. This optical path (solid line in FIG. 10) is one common route up to the nodes D4, C4, C3, B3, B2, and A2, which then branches into a first branch line from A2 to A1 and a second branch line from A2 to A3.
Communication between the user base Y and the base X1 is connected by the optical path from the common route to the first branch line.
Communication between the user base Y and the base X2 is connected by the optical path of the common route.
Communication between the user base Y and the base X3 is connected by the optical path from the common route to the second branch line.

The method shown in FIG. 10, even during a period where data are not received, the network resources of the normal optical paths (the first branch line, the second branch line) are secured in an occupied manner, and therefore the network resources are not utilized efficiently.

For example, even when attempting to create a new optical path (dashed line in FIG. 10) that passes through the route of the nodes D3, D2, D1, C1, B1, A1, A2 and connects a user base Z and the base X2, the existing optical path connecting the user base Y and the bases X1 to X3 (solid lines in FIG. 10) and the route partially overlap. Therefore, a new optical path cannot be created because the new optical path cannot use the network resources occupied by the existing optical path.

Thus, even the plurality of one-to-one communication methods shown in FIG. 9 and the one-to-many simultaneous communication method shown in FIG. 10 are not designed on the assumption of one-to-many switching communication. Thus, while communication is being performed between certain endpoints, only the wavelength resource used in the optical path connecting the other endpoints is occupied but not utilized.

Accordingly, a major challenge of the present invention is to improve the utilization efficiency of an optical path and to achieve optical communication at low costs when performing communication while switching one-to-multipoint communication in time series.

### Solution to Problem

In order to solve the challenge described above, an optical path design device of the present invention has the following features.

The present invention is an optical path design device for setting an optical path, wherein
the optical path design device sets an optical path connecting one fixed node which is a fixed endpoint to a plurality of switching nodes which are endpoints to be switched at different times, and includes:
a route calculation unit that calculates a route of an optical path including a route obtained by collecting common routes of a plurality of optical paths, for a route of the optical path for each of the switching nodes connecting the fixed node and each of the switching nodes; and
an optical path control unit that reserves communication resources used by an optical path whose period of use and wavelength used are designated on the route of the optical path calculated by the route calculation unit, and opens an optical path that uses the reserved wavelength in the reserved period of use.

### Advantageous Effects of Invention

According to the present invention, when communication is performed while switching one-to-multipoint communication in time series, utilization efficiency of an optical path can be improved, and optical communication can be achieved at low cost.

### BRIEF DESCRIPTION OF DRAWINGS

FIG. 1 is a configuration diagram of an optical path design device according to a present embodiment.

FIG. 2 is a flowchart showing processing performed by the optical path design device according to the present embodiment.

FIG. 3 is a configuration diagram showing an optical transmission system according to the present embodiment in which a wavelength is reserved on a candidate route of one-to-many communication.

FIG. 4 is a configuration diagram showing an optical transmission system in which a first optical path is created in the optical transmission system shown in FIG. 3 according to the present embodiment.

FIG. 5 is a configuration diagram showing the optical transmission system in which the first optical path is switched to a second optical path in the optical transmission system shown in FIG. 4 according to the present embodiment.

FIG. 6 is a configuration diagram showing the optical transmission system in which the second optical path is switched to a third optical path in the optical transmission system shown in FIG. 5 according to the present embodiment.

FIG. 7 is a hardware configuration diagram of the optical path design device according to the present embodiment.

FIG. 8 is a configuration diagram showing a network topology obtained before an optical path is configured in an optical transmission system.

FIG. 9 is a configuration diagram showing an optical transmission system in which a plurality of one-to-one communications are prepared in the optical transmission system shown in FIG. 8.

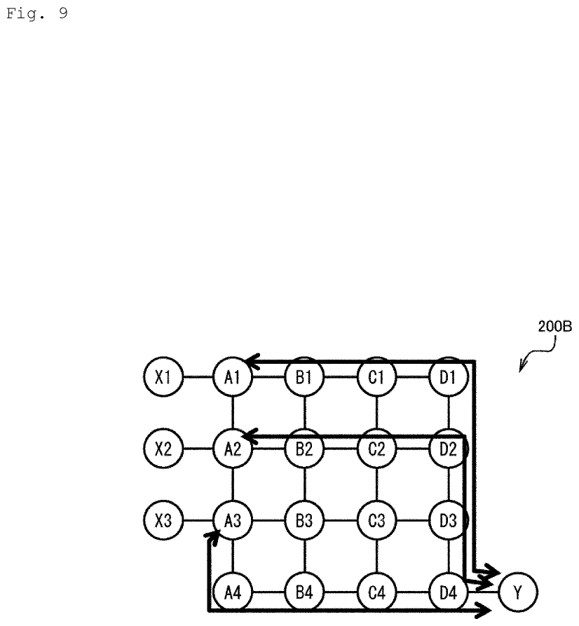

FIG. 10 is a configuration diagram showing an optical transmission system in which one-to-many simultaneous communications are prepared in the optical transmission system shown in FIG. 8.

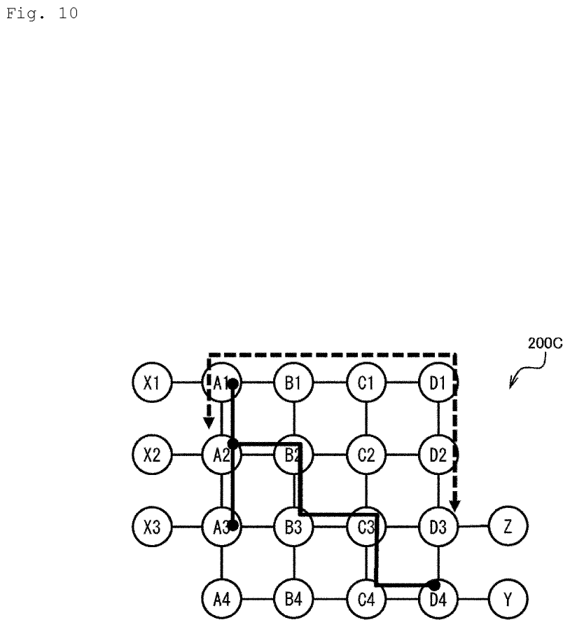

### DESCRIPTION OF EMBODIMENTS

One embodiment of the present invention will be described in detail below with reference to the drawings.

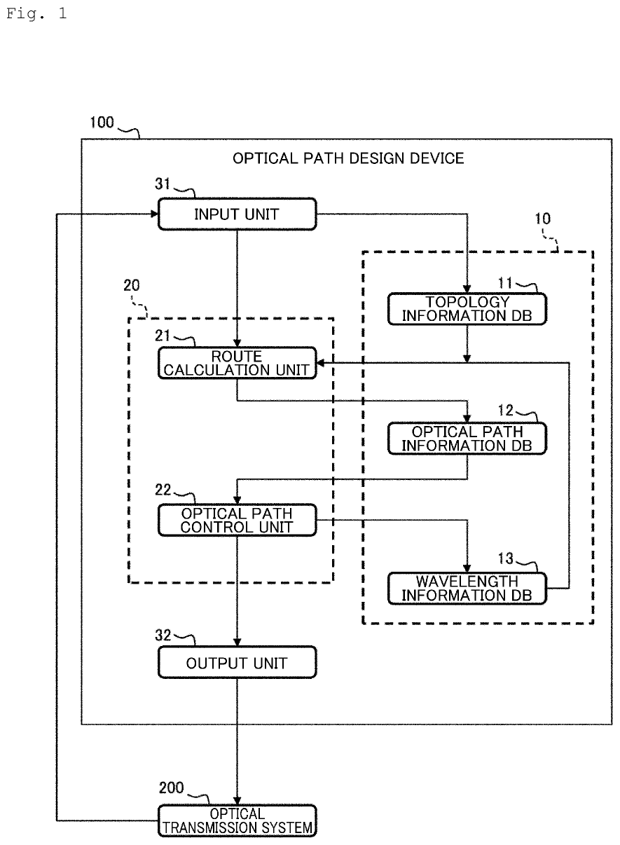

FIG. 1 is a configuration diagram of an optical path design device 100.

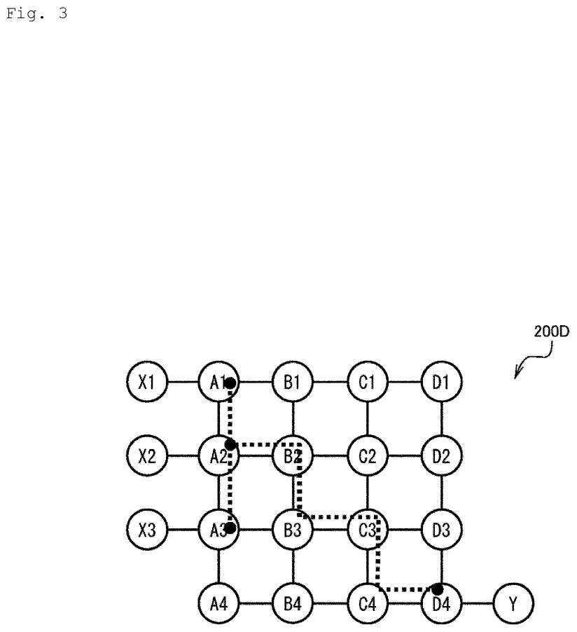

An optical transmission system 200 is a backbone network such as an IP communication network, which is a network in which communication by an optical signal is performed (details will be described with reference to FIG. 3 to FIG. 6). The optical path design device 100 is connected to the optical transmission system 200 via a network, and designs an optical path for one-to-many switching communication for the optical transmission system 200.

It should be noted that, in the following, an i-th optical path for one-to-many switching communication (i=1, 2, . . . , N) is an optical path where N endpoints on the multi-endpoint side are each a switching node. The combination of a fixed node on one endpoint side and the N switching nodes on the multi-endpoint side is called an “endpoint set.” The i-th optical paths created from the same endpoint set and connected to the same fixed node have different optical path IDs, but the wavelengths used are the same.

Also, as the order in which the i-th optical paths are used, a switching node to be initially opened is defined as a first switching node, and an optical path whose endpoint is the first switching node is defined as a first optical path. The node to be used next to the first switching node is defined as a second switching node, and an optical path whose endpoint is the second switching node is defined as a second optical path. Subsequently, similarly, an i-th optical path with an i-th switching node as an endpoint is created.

Designing an optical path is embodied by the following processing.
“Wavelength reservation” of an optical path refers to pre-processing in which the optical path design device 100 designates reservation contents (route of the optical path, wavelength used, and period of use) for the optical transmission system 200 (each node and each link), and exclusively uses one optical path within the designated range. Thus, the subsequent reservation that overlaps with the previously made reservation content is rejected.
“Creating” an optical path refers to processing in which the optical transmission system 200 (each node and each link) on the route of the optical path opens a new optical path connecting the endpoint set, to the optical transmission system 200. The opened optical path allows data transmission and reception to meet the communication demands of the endpoint set.
“Deleting” an optical path refers to processing in which the optical transmission system 200 (each node and each link) on the route of the optical path deletes the opened optical path from the optical transmission system 200.
“Switching” an optical path refers to processing in which the optical path design device 100 resets the optical path to the optical transmission system 200 (each node and each link) in order to switch the switching mode in one-to-many switching communication. For example, in order to perform the optical path switching processing for switching from the first optical path to the second optical path, the optical path design device 100 creates the second optical path after deleting the first optical path from the optical transmission system 200.

In this manner, the optical path design device 100 handles one-to-many switching communications in which the endpoint used by the optical path and the period of use thereof are determined in advance as the reservation contents. Therefore, it is desirable to apply to the present invention to the following optical transmission system 200 in which the time for switching the optical path is permitted.
Data center backup system
Low-priced optical path providing system
Optical path re-connection system in an unaffected area in the event of a disaster

Further, the optical path design device 100 is also suitable for use in designing an on-demand optical path in a future optical transmission system 200 in which many optical paths are disturbed and certainty of ensuring wavelength resources is required.

The “on-demand optical path” is an optical path in which a period of use is set. On the other hand, the optical path that is not on-demand (normal optical path) is an optical path that is basically used at all times after being opened without having its period of use set. Then, the optical transmission system 200 can suppress the non-operation period of the normal optical path by an operation method for setting the on-demand optical path for a limited time period according to the communication demand rather than an operation method for using the normal optical path in combination with various communication demands, and can efficiently utilize limited communication resources.

Furthermore, since the on-demand optical paths can be individually set in accordance with individual communication demands, appropriate optical paths can be opened without excess and deficiency of communication resources to be used even for communication demands on which severe requirements are imposed. Severe requirements are, for example, delay requirements, reliability requirements, band requirements, and the like. On the other hand, if the optical path is always used for various communication demands, an excess of communication resources or shortages of communication resources may occur in some cases.

The optical path design device 100 includes a storage unit 10, an optical path design unit 20, an input unit 31, and an output unit 32.

The input unit 31 inputs information such as information on a communication demand communicated via the optical path. The information on a communication demand is, for example, the following information in an optical path setting request for one-to-many switching communication.
Fixed nodes of an endpoint set.
A plurality of switching nodes of the endpoint set. The respective switching nodes have different periods of use, and the switching node to be used is changed over time.
Period of use and order of use of each switching node.

The output unit 32 reflects the design contents of an optical path on the optical transmission system 200 by outputting, as execution results of the optical path design device 100, results of wavelength reservation and control of the optical path (create, delete, switch) to the optical transmission system 200.

A topology information DB11, an optical path information DB12, and a wavelength information DB13 are stored in the storage unit 10.

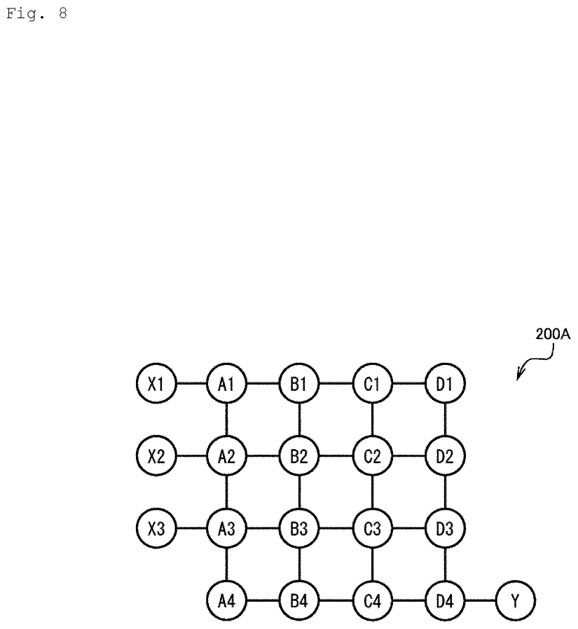

The topology information DB11 stores, as topology information of the optical transmission system 200, information representing a connection relationship between nodes and links (see FIG. 8 and the like) and information on the distance between nodes (link cost and the like).

The optical path information DB 12 stores, as information on an optical path to be opened in the optical transmission system 200, route information of the optical path calculated by a route calculation unit 21, and the like. The wavelength information DB13 stores wavelength reservation information (wavelength allocation situation) for each link of the optical transmission system 200.

The optical path design unit 20 includes the route calculation unit 21 and an optical path control unit 22.

The route calculation unit 21 calculates a route of an optical path by, for example, solving a minimum spanning tree problem for an endpoint set by means of Kruskal's algorithm, on the basis of the information obtained from the input unit 31.

The term “spanning tree” refers to a tree obtained by deleting sides while maintaining the condition that a non-directed linked graph is linked.

The term “minimum spanning tree” means that the sum of the costs of the sides constituting the spanning tree is minimum. The term “minimal spanning tree problem” refers to a problem to find the minimal spanning tree or its cost of a given graph. In this case, one of the following is used as the cost.
The number of hops
Sum of wavelength utilization
Distance.
Costs based on the bandwidth and connection distance of the optical path

The optical path control unit 22 instructs the optical transmission system 200 to control the optical path (create, delete, switch, reserve wavelength) according to the information obtained from the input unit 31 and the route of the optical path obtained from the route calculation unit 21. Each of the processing units and each of the DB of the optical path design device 100 described above are examples; the optical path design device 100 may further include another processing unit or another DB. Furthermore, the optical path design device 100 may be implemented as one device or as a group of a plurality of devices that share roles.

Thus, the optical path design device 100 shown in FIG. 1 sets an optical path that connects one fixed node which is a fixed endpoint and a plurality of switching nodes which are endpoints to be switched at different times.

The route calculation unit 21 calculates a route of an optical path that includes a route obtained by collecting common routes of a plurality of optical paths, for the route of the optical path for each switching node that connects the fixed node and each switching node.

The optical path control unit 22 reserves communication resources used by an optical path whose period of use and wavelength used are designated on the route of the optical path calculated by the route calculation unit 21, and opens the optical path that uses a reserved wavelength in a reserved period of use.

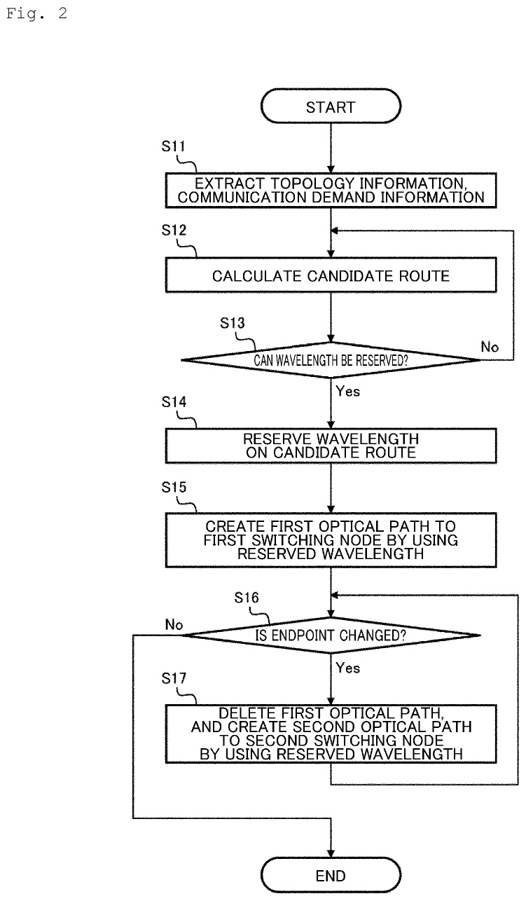

FIG. 2 is a flowchart showing processing performed by the optical path design device 100.

The input unit 31 extracts, from the input information, topology information to be stored in the topology information DB11 in addition to the information on the communication demand described above (S11).

The route calculation unit 21 refers to the topology information DB11 to calculate a candidate route for an optical path connecting endpoint sets included in the information on the communication demand extracted in S11 (S12).

The optical path control unit 22 refers to the wavelength information DB 13 to determine whether or not a wavelength can be reserved for the candidate route obtained in S12 (S13). If a wavelength cannot be reserved this time (No in S13), the optical path control unit 22 returns the processing to S12 and causes the route calculation unit 21 to calculate another candidate route. That is, in a case where another reservation that overlaps with the period of use and the wavelength used on the already reserved route occurs, the optical path control unit 22 rejects another reservation.

The result of the step S13 becomes “No” when, for example, there is an overlap in reservation contents (the route of the optical path, wavelength used, and period of use) between a pre-reservation in the wavelength information DB13 and a future reservation accepted this time, or when the wavelength information DB13 does not enough wavelength resources that can be newly reserved.

On the other hand, if the result of the step S13 is “Yes,” the optical path control unit 22 reserves the same wavelength for all links included in the candidate route obtained in S12, and writes the result to the wavelength information DB13 (S14).

When the period of use of the wavelength reserved in S14 comes, the optical path control unit 22 creates the first optical path between the fixed node and the first switching node by using the wavelength reserved from the wavelength information DB13, and the result to the optical path information DB12 (S15). Then, the output unit 32 reflects the first optical path in the optical path information DB12 on the optical transmission system 200, whereby the first optical path is opened between the fixed node and the first switching nodes.

The optical path control unit 22 determines whether or not there occurs an opportunity to change an end point, a communication partner of the fixed node, from the first switching node to the second switching node (S16). For example, in a case where the current time is outside the period of use of the first switching node but is within the period of use of the second switching node, the result of the step S16 becomes Yes, and the processing shifts to the step S17. On the other hand, in a case where such opportunity does not occur (No in S16), the optical path control unit 22 ends the processing.

The optical path control unit 22 deletes the first optical path of S15 from the optical path information DB12. Then, the optical path control unit 22 creates the second optical path between the fixed node and the second switching node by using the wavelength reserved in the step S14, and writes the result to the optical path information DB12 (S17). Then, the output unit 32 reflects the deletion of the first optical path and the creation of the second optical path on the optical transmission system 200 in accordance with the information stored in the optical path information DB12. Switching from the second optical path to the third optical path or switching of the subsequent optical path is treated in the same manner.

In this manner, the optical path control unit 22 switches from the first optical path to the second optical path. The first optical path and the second optical path use the same wavelength but have different routes.

That is, when the period of use of a predetermined switching node expires and the period of use of another switching node starts, the optical path control unit 22 deletes the first optical path opened to be connected to the predetermined switching node, and newly opens the second optical path to be connected to said another switching node.

Hereinafter, specific examples of the optical transmission system 200 shown in FIG. 1 will be described with reference to FIGS. 3 to 6.

FIG. 3 is a configuration diagram showing an optical transmission system 200D in which a wavelength is reserved on a candidate route of one-to-many communication in the optical transmission system 200A shown in FIG. 8 (S14).

The route calculation unit 21 calculates the route of the optical path indicated by the broken line in FIG. 3 by, for example, solving a minimum spanning tree problem connecting a fixed node and a switching node.

The optical path control unit 22 reserves the same wavelength for the respective links of the candidate route with respect to the optical paths of the fixed node D4 and switching nodes A1, A2, A3 (S14).

In FIG. 3, there are three periods of use of each link to be reserved, as follows: The link D4-C4 means a link connecting the node D4 and the node C4.
Each common section of the link D4-C4, the link C4-C3, the link C3-B3, the link B3-B2, and the link B2-A2 is used not only in the first optical path connecting the user base Y and the base X2 via the first switching node A2 but also in the second and third optical paths described later. Therefore, each common section is reserved in the periods of use of all the optical paths (the first to third optical paths) for one-to-many communication.
The link A2-A1 is a branch section used only in the second optical path connecting the user base Y and the base X1 via the second switching node A1, and is reserved in the period of use of the second optical path.
The link A2-A3 is a branch section used only in the third optical path connecting the user base Y and the base X3 via the third switching node A3, and is reserved in the period of use of the third optical path.

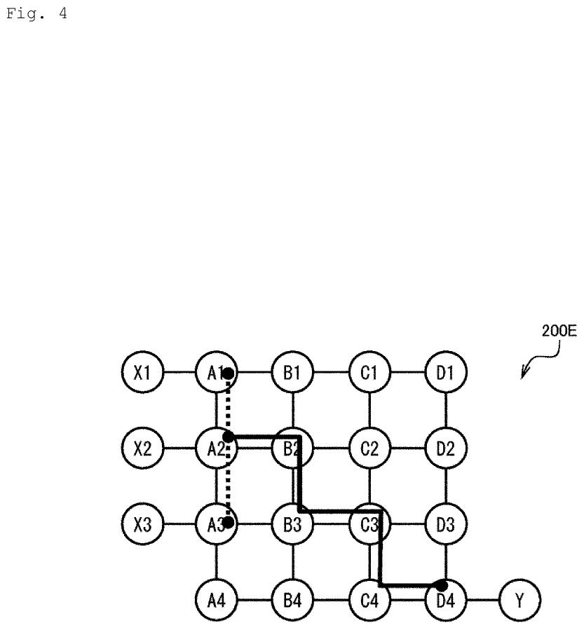

FIG. 4 is a configuration diagram showing an optical transmission system 200E in which the first optical path is created (S15) in the optical transmission system 200D shown in FIG. 3.

The optical path control unit 22 creates the first optical path for connecting the user base Y and the base X2 along the collected route (nodes D4, C4, C3, B3, B2, A2) of the common section (S15). Note that, in FIG. 4, the route of the first optical path opened between the nodes D4 and A2 is shown by a solid line.

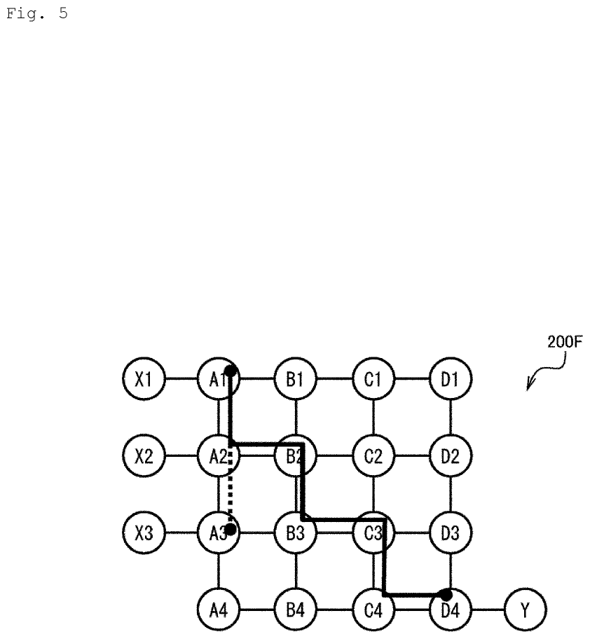

FIG. 5 is a configuration diagram showing an optical transmission system 200F in which the first optical path is switched to the second optical path (S17) in the optical transmission system 200E shown in FIG. 4.

After deleting the first optical path from the optical transmission system 200E, the optical path control unit 22 creates the second optical path for connecting the user base Y and the base X1 along the route branching from the common section to the link A2-A1 (nodes D4, C4, C3, B3, B2, A2, A1) (S17). Note that in the optical transmission system 200F shown in FIG. 5, the route of the second optical path that has been opened between the nodes D4 and A1 is shown by the solid lines.

Here, the optical path control unit 22 can quickly switch the optical path while saving the resources when changing an endpoint by making an optical path reservation for a plurality of endpoints in advance.

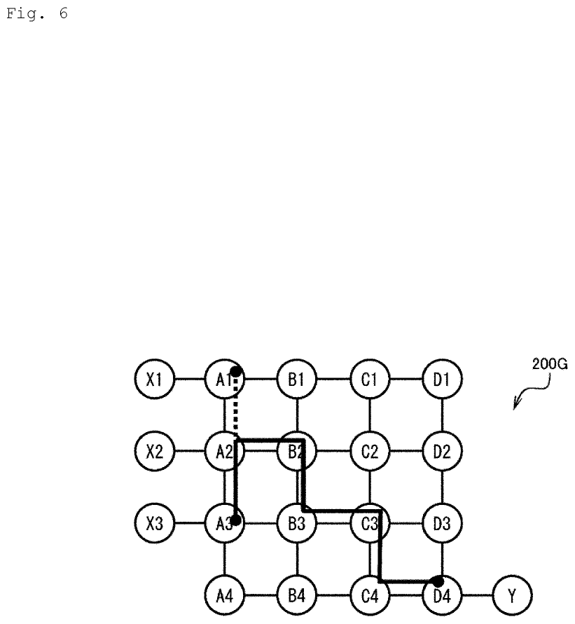

FIG. 6 is a configuration diagram showing an optical transmission system 200G in which the second optical path is switched to the third optical path (second S17) in the optical transmission system 200F shown in FIG. 5.

After deleting the second optical path from the optical transmission system 200F, the optical path control unit 22 creates the third optical path for connecting the user base Y and the base X3 along the route branching from the common section to the link A2-A3 (nodes D4, C4, C3, B3, B2, A2, A3) (second S17). Note that, in the optical transmission system 200G shown in FIG. 6, the route of the third optical path opened between the nodes D4 and A3 is shown by the solid lines.

The optical transmission system 200 described above is applied to, for example, the following distribution system services.
Interactive real-time video distribution services. This is a service where, for example, in live viewing or the like, a large audience and an artist remote from each other can perform high-quality communication with high quality video and real-time communication.
Channel-switched distribution services. In other words, this is a services where, in a video distribution service, a fixed node of a viewer switches a plurality of video distribution servers (switching nodes) to receive video data.
High-reality video distribution services using highly immersive videos such as XR (Cross Reality) and Volumetric Video.
Inter-site communication services such as camera video traffic (transmission to monitoring sites in real time with a plurality of monitoring camera videos in the plant).

Furthermore, the optical transmission system 200 may be applied to the following services, for example.
Data center backup service (backup from the same user site to a plurality of data centers, backup of data from a certain data center to another data center, etc.).
Remote control services. Examples thereof include a remote surgery for switching between switching nodes (doctor terminal and technician terminal) with respect to a fixed node (medical terminal in the operating room). Alternatively, the switching nodes (a plurality of devices in a plant at a remote location) from a fixed node (operator terminal). Further, a drone distribution service may be possible in which a switching node (each drone terminal) is remotely operated from a fixed node (deliverer terminal).
Core network connectivity services for mobile base stations.

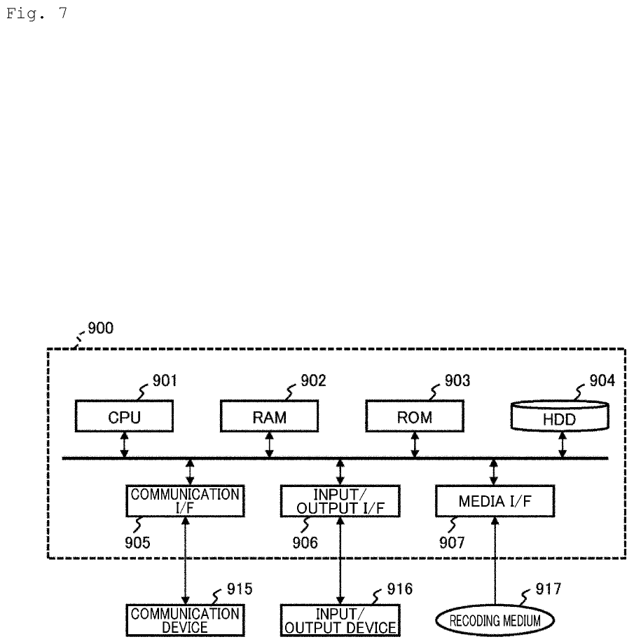

FIG. 7 is a hardware configuration diagram of the optical path design device 100.

The optical path design device 100 is configured as a computer 900 that includes a CPU 901, a RAM 902, a ROM 903, an HDD 904, a communication I/F 905, an input/output I/F 906, and a medium I/F 907.

The communication I/F 905 is connected to an external communication device 915. The input/output I/F 906 is connected to an input/output device 916. The medium I/F 907 reads/writes data from/to a recording medium 917. Further, the CPU 901 controls each unit by executing a program (an optical path design program) loaded into the RAM 902. In addition, this program (an application, also referred to as an app for short) can also be distributed via a communication line, or recorded on the recording medium 917 such as a CD-ROM and distributed.

### Effects

The optical path design device 100 of the present invention sets an optical path for connecting one fixed node which is a fixed endpoint and a plurality of switching nodes that are endpoints to be switched at different times, and includes: a route calculation unit 21 that calculates a route of an optical path including a route obtained by collecting common routes of a plurality of optical paths, for a route of the optical path for each of the switching nodes connecting the fixed node and each of the switching nodes; and an optical path control unit 22 that reserves communication resources used by an optical path whose period of use and wavelength used are designated on the route of the optical path calculated by the route calculation unit 21, and opens an optical path that uses the reserved wavelength in the reserved period of use.

Thus, the optical path design device 100 reserves an optical path of a route in which the common routes are collected, while limiting the period of use. Thus, when communicating while switching one-to-multipoint communication in time series, the optical path design device 100 reduces the amount of resources occupied by the optical path, to improve the utilization efficiency of the optical path and achieve optical communication at low cost.

That is, regarding a plurality of optical paths connecting the same fixed node, the amount of reserved resources can be reduced by providing a common route rather than setting a plurality of optical paths between endpoints without providing a common route. By reducing the amount of reserved resources, a communication carrier or a service carrier can benefit from the cost reduction, which allows more room for communication resources, the communication carrier or service carrier can cope with unexpected demands for communication resources due to the impact of a disaster or the like, because there is a margin for communication resources.

The optical path design device 100 of the present invention is characterized in that the route calculation unit 21 calculates a route of an optical path by solving a minimum spanning tree problem that connects the fixed node and each of the switching nodes.

Thus, since the optical path design device 100 can set the route of the optical path so as to bypass a high-cost link such as a narrow-band link, the cost of opening the optical path can be reduced.

The optical path design device 100 of the present invention is characterized in that, when another reservation that overlaps with a period of use and a wavelength used on an already reserved route occurs, the optical path control unit 22 rejects another reservation.

Thus, the optical path design device 100 can use the optical path when necessary without constantly opening the optical path, by preventing duplicate reservation.

The optical path design device 100 of the present invention is characterized in that, when a period of use of a predetermined switching node expires and a period of use of another switching node starts, the optical path control unit 22 deletes a first optical path opened to be connected to the predetermined switching node, and newly opens a second optical path to be connected to said another switching node.

Thus, the optical path design device 100 can improve the utilization efficiency of communication resources by appropriately generating or deleting an optical path whose period of use is limited.

### REFERENCE SIGNS LIST

10 Storage unit
11 Topology information DB
12 Optical path information DB
13 Wavelength information DB
20 Optical path design unit
21 Route calculation unit
22 Optical path control unit
31 Input unit
32 Output unit
100 Optical path design device
200 Optical transmission system

1. An optical path design device for setting an optical path, wherein
the optical path design device is implemented using one or more computers and is configured to:
set an optical path connecting one fixed node which is a fixed endpoint to a plurality of switching nodes which are endpoints to be switched at different times, and
calculate a route of an optical path including a route obtained by collecting common routes of a plurality of optical paths, for a route of the optical path for each of the switching nodes connecting the fixed node and each of the switching nodes; and
reserve communication resources used by an optical path whose period of use and wavelength used are designated on the route of the optical path calculated, and opens an optical path that uses a reserved wavelength in a reserved period of use.

2. The optical path design device according to claim 1, wherein a route of an optical path is calculated by solving a minimum spanning tree problem connecting the fixed node and each of the switching nodes.

3. The optical path design device according to claim 1, wherein, in a case where another reservation that overlaps with a period of use and a wavelength used on an already reserved route occurs, the optical path design device is configured to reject another reservation.

4. The optical path design device according to claim 1, wherein when a period of use of a predetermined switching node expires and a period of use of another switching node starts, the optical path path design device is configured to delete a first optical path opened to be connected to the predetermined switching node, and newly opens a second optical path to be connected to said another switching node.

5. An optical path design method in which an optical path design device setting an optical path, the optical path design method comprising:
setting an optical path connecting one fixed node which is a fixed endpoint to a plurality of switching nodes which are endpoints to be switched at different times by the optical path design device;
calculating a route of an optical path including a route obtained by collecting common routes of a plurality of optical paths, for a route of the optical path for each of the switching nodes connecting the fixed node and each of the switching nodes; and
reserving communication resources used by an optical path whose period of use and wavelength used are designated on the route of the optical path calculated, and opening an optical path that uses a reserved wavelength in a reserved period of use.

6. A non-transitory computer readable medium storing instructions of an optical path design program that, upon execution by a computer, causes the computer to perform operations of an optical path design device, the operations comprising:
setting an optical path connecting one fixed node which is a fixed endpoint to a plurality of switching nodes which are endpoints to be switched at different times by the optical path design device;
calculating a route of an optical path including a route obtained by collecting common routes of a plurality of optical paths, for a route of the optical path for each of the switching nodes connecting the fixed node and each of the switching nodes; and
reserving communication resources used by an optical path whose period of use and wavelength used are designated on the route of the optical path calculated, and opening an optical path that uses a reserved wavelength in a reserved period of use.
